(19) United States
(12) Patent Application Publication
(10) Pub. No.: US 2022/0144105 A1
(43) Pub. Date: May 12, 2022

(54) CONTROL DEVICE, NON-CONTACT POWER SUPPLY DIAGNOSTIC PROGRAM, AND NON-CONTACT POWER SUPPLY SYSTEM

(71) Applicant: TOYOTA JIDOSHA KABUSHIKI KAISHA, Toyota-shi (JP)

(72) Inventors: Toshiya HASHIMOTO, Miyoshi-shi (JP); Ayano KIMURA, Susono-shi (JP); Hikaru SHIOZAWA, Susono-shi (JP); Chuya OGAWA, Susono-shi (JP); Yuta MANIWA, Susono-shi (JP)

(73) Assignee: TOYOTA JIDOSHA KABUSHIKI KAISHA, Toyota-shi (JP)

(21) Appl. No.: 17/395,982

(22) Filed: Aug. 6, 2021

(30) Foreign Application Priority Data
Nov. 10, 2020 (JP) 2020-187141

(51) Int. Cl. B60L 53/124; B60L 53/122

(52) U.S. Cl. CPC B60L 53/124; B60L 53/122

(57) ABSTRACT

A control device includes a processor configured to determine whether a non-contact power supply device is normal based on an induction current that passes through a power receiving coil of a non-contact power receiving device due to power supply via a power supply coil of the non-contact power supply device.

### CROSS-REFERENCE TO RELATED APPLICATION

This application claims priority to Japanese Patent Application No. 2020-187141 filed on Nov. 10, 2020, incorporated herein by reference in its entirety.

### BACKGROUND

### 1. Technical Field

The present disclosure relates to a control device, a non-contact power supply diagnostic program, and a non-contact power supply system.

### 2. Description of Related Art

WO 2011/142419 discloses a resonant non-contact power supply system provided with power supply equipment having a primary resonance coil that receives electric power from an alternating current (AC) power source and mobile equipment having a secondary resonance coil that receives electric power from the primary resonance coil.

### SUMMARY

If the non-contact power supply device that supplies power to the vehicle in a non-contact manner is out of order, it is not possible to supply power to the vehicle in a non-contact manner. Therefore, it is required to determine whether the non-contact power supply device is normal.

The present disclosure has been made in view of the above, and an object thereof is to provide a control device, a non-contact power supply diagnostic program, and a non-contact power supply system that are all capable of determining whether a non-contact power supply device is normal.

A control device according to the present disclosure includes a processor configured to determine whether a non-contact power supply device is normal based on an induction current that passes through a power receiving coil of a non-contact power receiving device due to power supply via a power supply coil of the non-contact power supply device.

A non-contact power supply diagnostic program according to the present disclosure causes a processor to determine whether a non-contact power supply device is normal based on an induction current that passes through a power receiving coil of a non-contact power receiving device due to power supply via a power supply coil of the non-contact power supply device.

A non-contact power supply system according to the present disclosure includes: a non-contact power supply device including a power supply coil and a first processor; and a control device including a second processor configured to determine whether the non-contact power supply device is normal based on an induction current that passes through a power receiving coil of a non-contact power receiving device due to power supply via the power supply coil of the non-contact power supply device.

According to the present disclosure, the control device, the non-contact power supply diagnostic program, and the non-contact power supply system exert an effect that makes it possible to determine whether the non-contact power supply device is normal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a non-contact power supply system according to an embodiment;

FIG. 2 is a schematic configuration diagram of a non-contact power receiving device and a non-contact power supply device;

FIG. 3 is a schematic configuration diagram of an in-vehicle terminal;

FIG. 4 is a diagram showing a first example of a power supply diagnostic control routine;

FIG. 5 is a diagram showing a second example of the power supply diagnostic control routine;

FIG. 6 is a diagram showing a case where a vehicle is used to perform a power supply diagnosis and a foreign matter detection diagnosis of the non-contact power supply device; and

FIG. 7 is a diagram showing a control routine for the power supply diagnosis and the foreign matter detection diagnosis.

### DETAILED DESCRIPTION OF EMBODIMENTS

Hereinafter, an embodiment of a non-contact power supply system according to the present disclosure will be described. The present embodiment does not limit the present disclosure.

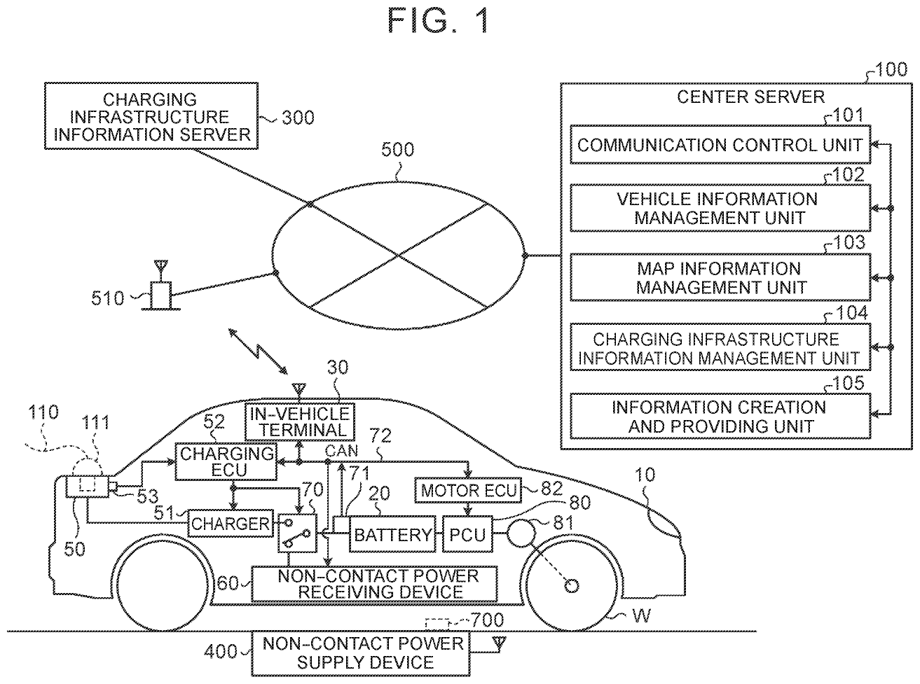

FIG. 1 is a diagram showing a non-contact power supply system according to an embodiment. A vehicle 10 to which the non-contact power supply system is applied is an electric vehicle that travels by driving a traction motor using electric power from a battery.

The non-contact power supply system includes an in-vehicle terminal 30, a center server 100, a charging infrastructure information server 300, a non-contact power supply device 400, and a communication network 500. The in-vehicle terminal 30 is an in-vehicle information communication terminal device associated with the vehicle 10. The center server 100 functions as a navigation server provided in a vehicle information center. The charging infrastructure information server 300 is provided in a charging infrastructure center. The non-contact power supply device 400 is provided in a road that is a travel road of the vehicle 10. The communication network 500 is the Internet or the like through which the in-vehicle terminal 30, the center server 100, the charging infrastructure information server 300, and the non-contact power supply device 400 are connected so as to be able to communicate with each other. A wireless base station 510 is connected to the communication network 500, and the in-vehicle terminal 30 is connected to the communication network 500 via the wireless base station 510.

The vehicle 10 includes a battery 20 that serves as an energy source for traveling. The vehicle 10 has two power supply systems including a cable-connected power supply system in which power is supplied from an external power supply to the battery 20 via a charging cable 110, and a non-contact power supply system in which electric power transmitted from the non-contact power supply device 400 is received in a non-contact manner and supplied to the battery 20.

The cable-connected power supply system includes a power receiving port 50, a charger 51, and a charging electronic control unit (ECU) 52. The power receiving port 50 is a connection port for a connection plug 111 of the charging cable 110. The charger 51 converts electric power supplied to the power receiving port 50 into electric power for charging the battery 20, and charges the battery 20. The charging ECU 52 is a charging control device that controls charging of the battery 20 by the charger 51. The non-contact power supply system includes a non-contact power receiving device 60. An output terminal of the charger 51 and an output terminal of the non-contact power receiving device 60 are each connected to an input terminal of a selection switch 70. One of the output of the charger 51, which is the output of the cable-connected power supply system, and the output of the non-contact power receiving device 60 is selectively supplied to a charging path to the battery 20 by the selection switch 70.

The battery 20 is provided with a state of charge (SOC) detector 71 that detects an SOC, which is a value indicating the state of charge of the battery 20. The SOC detector 71 outputs, as the SOC, a signal representing a value serving as an index of the amount of electric energy that can be output from the battery 20. The SOC detector 71 outputs the signal to a controller area network (CAN) communication line 72 of a CAN communication system at a predetermined cycle. Hereinafter, the SOC detected by the SOC detector 71 is also referred to as a remaining battery level. The remaining battery level may be represented by, for example, a charge rate [%] or the amount of electric energy that can be output from the battery 20.

The charging ECU 52 is configured by using a microcomputer including: a processor including a central processing unit (CPU) or a field-programmable gate array (FPGA), and a memory including a random access memory (RAM) or a read only memory (ROM). To charge the battery 20, the charging ECU 52 acquires the remaining battery level detected by the SOC detector 71 through the CAN communication line 72. The charging ECU 52 activates the charger 51 to charge the battery 20 until the remaining battery level reaches a target value set by a user (for example, fully charged battery level). Moreover, the charging ECU 52 changes the selection status of the selection switch 70 so that the cable-connected power supply system is electrically connected to the battery 20 when the connection plug 111 of the charging cable 110 is attached to the power receiving port 50. Moreover, the charging ECU 52 changes the selection status of the selection switch 70 so that the non-contact power supply system is electrically connected to the battery 20 when the connection plug 111 of the charging cable 110 is not attached to the power receiving port 50. The power receiving port 50 is provided with a detection switch 53 that detects whether the connection plug 111 is connected to the power receiving port 50. The charging ECU 52 receives a detection signal from the detection switch 53 to determine whether the connection plug 111 is connected, and controls switching by the selection switch 70.

The vehicle 10 includes, as a traveling drive system configuration, a power control unit (PCU) 80, a motor 81 for traveling, and a motor ECU 82. The PCU 80 converts direct current (DC) power output from the battery 20 into three-phase alternating current (AC) power. The motor 81 is driven by the three-phase AC power output from the PCU 80 to rotate wheels W. The motor ECU 82 is a motor control unit that controls the output of the PCU 80 in accordance with the driving operation of a driver. The motor ECU 82 is configured by using a microcomputer including a processor including a CPU or an FPGA and a memory including a RAM or a ROM.

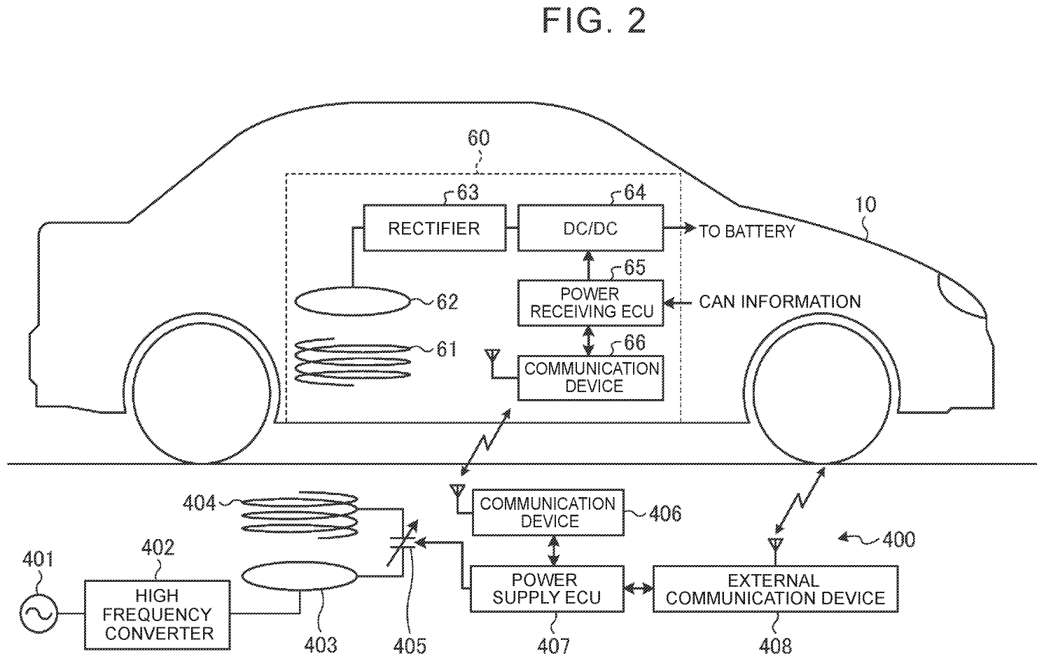

FIG. 2 is a schematic configuration diagram of the non-contact power receiving device 60 and the non-contact power supply device 400. The non-contact power receiving device 60 provided in the non-contact power supply system is supplied with power in a non-contact manner from the non-contact power supply device 400 provided in a road. The non-contact power supply device 400 includes an AC power supply 401, a high frequency converter 402, an electromagnetic induction coil 403, a primary coil 404, a variable capacitor 405, a communication device 406, a power supply ECU 407 serving as a power supply control device, and an external communication device 408. The power supply ECU 407 is configured by using a microcomputer including a processor including a CPU or an FPGA and a memory including a RAM or a ROM.

The AC power supply 401 is, for example, a system power supply that is supplied by an electric company. The high frequency converter 402 converts electric power supplied from the AC power supply 401 into electric power having a predetermined frequency, and outputs the converted electric power to the electromagnetic induction coil 403. The electromagnetic induction coil 403 is disposed coaxially with the primary coil 404, and can be magnetically coupled to the primary coil 404 through electromagnetic induction. The electromagnetic induction coil 403 outputs, through electromagnetic induction, the high frequency power supplied from the high frequency converter 402 to the primary coil 404.

The primary coil 404 serving as a power supply coil is an inductor-capacitor (LC) resonance coil, and configured to be capable of transmitting power to the vehicle 10 by resonating with a secondary coil 61 of the non-contact power receiving device 60 mounted in the vehicle 10 via an electromagnetic field. The variable capacitor 405 is provided to change the capacitance of a resonance system constituted by the primary coil 404 and the secondary coil 61 of the non-contact power receiving device 60.

The communication device 406 is provided to receive position information of the vehicle 10 to which power is supplied, specifically, position information of the secondary coil 61 of the non-contact power receiving device 60 mounted on the vehicle 10, and a detected value of the speed of the vehicle 10. The communication device 406 receives the position information and the detected value of the speed of the vehicle 10 that are wirelessly transmitted from a communication device 66 provided in the non-contact power receiving device 60.

When power is supplied from the non-contact power supply device 400 to the vehicle 10, the power supply ECU 407 changes the capacitance of the resonance system constituted by the primary coil 404 and the secondary coil 61 of the non-contact power receiving device 60 in accordance with the position information and the detected value of the speed of the vehicle 10 that are received by the communication device 406. When the distance between the primary coil 404 and the secondary coil 61 of the non-contact power receiving device 60 changes, the capacitance between the primary coil 404 and the secondary coil 61 changes, so that the resonance frequency of the resonance system changes. When the resonance frequency deviates significantly from the frequency of transmitted power, that is, the frequency of high frequency electric power generated by the high frequency converter 402, transmission efficiency is significantly reduced. Therefore, the power supply ECU 407 controls the variable capacitor 405 in accordance with the position information and the detected value of the speed of the vehicle 10 such that the resonance frequency of the resonance system is close to the frequency of the high frequency electric power generated by the high frequency converter 402. The power supply ECU 407 thus adjusts the capacitance of the resonance system. For example, the power supply ECU 407 adjusts the capacitance of the variable capacitor 405 to be smaller as the vehicle speed is higher, and to be smaller as the vehicle 10 is farther from the non-contact power supply device 400 (as the distance between the primary coil 404 and the secondary coil 61 is larger).

The external communication device 408 transmits information indicating the operation status of the non-contact power supply device 400 and the like to the charging infrastructure information server 300 at a predetermined cycle via the communication network 500. In this case, the external communication device 408 adds identification data (ID) for identifying the non-contact power supply device 400, and then transmits the operation status information (information indicating whether power can be supplied). Many non-contact power supply devices 400 are provided on the road. Therefore, in the charging infrastructure center, it is possible to grasp which non-contact power supply device 400 is operating in the controlled area of the charging infrastructure center.

The non-contact power receiving device 60 mounted on the vehicle 10 includes the secondary coil 61, an electromagnetic induction coil 62, a rectifier 63, a DC/DC converter 64, a power receiving ECU 65 that is a power receiving control device, and the communication device 66. The power receiving ECU 65 is configured by using a microcomputer including a processor including a CPU or an FPGA and a memory including a RAM or a ROM.

The secondary coil 61 that is a power receiving coil is an LC resonance coil, and configured to be capable of receiving power from the non-contact power supply device 400 by resonating with the primary coil 404 of the non-contact power supply device 400 via an electromagnetic field. The electromagnetic induction coil 62 is disposed coaxially with the secondary coil 61, and can be magnetically coupled to the secondary coil 61 through electromagnetic induction. The electromagnetic induction coil 62 obtains, through electromagnetic induction, electric power received by the secondary coil 61 and outputs the electric power to the rectifier 63. The rectifier 63 rectifies the AC power output from the electromagnetic induction coil 62 and outputs the rectified electric power to the DC/DC converter 64. The DC/DC converter 64 converts the electric power rectified by the rectifier 63 into a charging voltage level of the battery 20 and outputs the electric power to the battery 20. The power receiving ECU 65 charges the battery 20 by driving the DC/DC converter 64 when power is received from the non-contact power supply device 400. Moreover, the power receiving ECU 65 acquires information indicating the vehicle speed and the position of the vehicle from the CAN communication line 72, and outputs the acquired information indicating the vehicle speed and the position of the vehicle to the communication device 66. The communication device 66 wirelessly transmits the information indicating the vehicle speed and the position of the vehicle to the external communication device 408 of the non-contact power supply device 400.

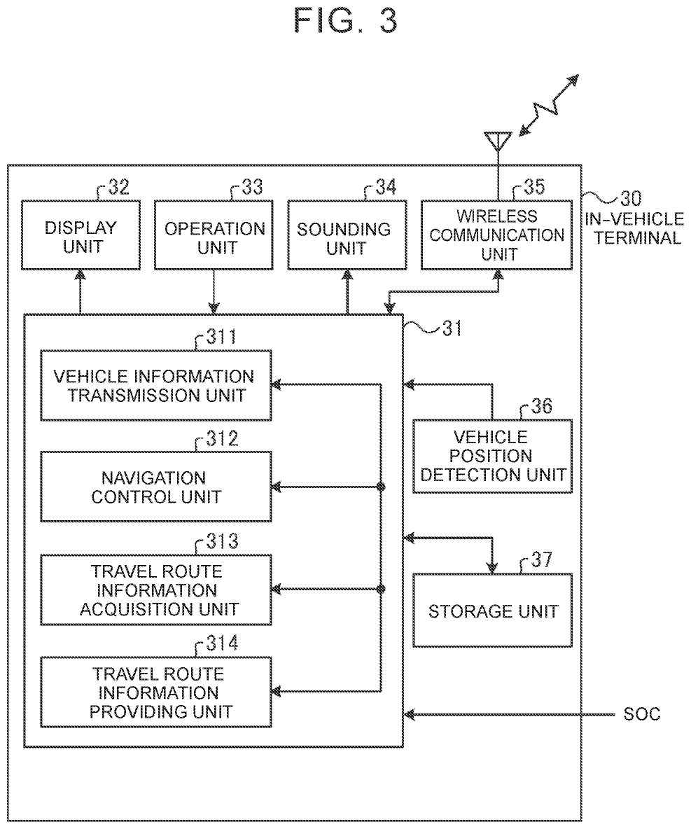

Next, a description will be given of the in-vehicle terminal 30. FIG. 3 is a schematic configuration diagram of the in-vehicle terminal 30. The in-vehicle terminal 30 includes a main control unit 31, a display unit 32, an operation unit 33, a sounding unit 34, a wireless communication unit 35, a vehicle position detection unit 36, and a storage unit 37. The main control unit 31 is configured by using a microcomputer including a processor including a CPU or an FPGA and a memory including a RAM or a ROM. The display unit 32 and the operation unit 33 are configured by using a touch panel display such as a liquid crystal display and an organic electro-luminescence (EL) display. The sounding unit 34 is configured by using an amplifier, a speaker, and the like to provide voice guidance. The wireless communication unit 35 communicates with the outside via the wireless base station 510. The vehicle position detection unit 36 includes a Global Positioning System (GPS) unit that detects the current position coordinates of the vehicle based on radio waves from GPS satellites, and a gyro sensor that detects the traveling direction of the vehicle 10. The storage unit 37 is configured by using a storage device such as an erasable programmable ROM (EPROM) and a hard disk drive (HDD). The storage unit 37 stores map information, facility information, and information such as various vehicle characteristics.

The vehicle 10 has vehicle ECUs that are a plurality of electronic control units that controls the vehicle status. The vehicle ECUs including: the charging ECU 52; the power receiving ECU 65; and the motor ECU 82, and the SOC detector 71 are connected to the CAN communication line 72, and transmit various vehicle information (for example, mileage information, SOC information, vehicle diagnostics information, and various request information) to the CAN communication line 72. Therefore, each vehicle ECU is configured to be able to share vehicle information via the CAN communication line 72. The in-vehicle terminal 30 is connected to the CAN communication line 72, and transmits to the center server 100 vehicle information transmitted to the CAN communication line 72 in accordance with a predetermined procedure. The center server 100 transmits service information useful to the user to the in-vehicle terminal 30 based on the vehicle information transmitted from the in-vehicle terminal 30 and the external information acquired from the outside.

The main control unit 31 provided in the in-vehicle terminal 30 includes a vehicle information transmission unit 311, a navigation control unit 312, a travel route information acquisition unit 313, and a travel route information providing unit 314. The vehicle information transmission unit 311 transmits to the center server 100 information of the vehicle (for example, current position information, SOC information, power consumption information, and vehicle diagnostics information) and various request instructions in addition to a vehicle ID (ID for identifying the vehicle 10 or the in-vehicle terminal 30). The navigation control unit 312 guides the vehicle to the destination set by the user based on the map information stored in the storage unit 37 and the vehicle position detected by the vehicle position detection unit 36. The travel route information acquisition unit 313 acquires travel route information transmitted from the center server 100 and detailed information related to the travel route information. The travel route information providing unit 314 uses the display unit 32 to provide the user with the travel route information acquired by the travel route information acquisition unit 313 and the detailed information related to the travel route information. The vehicle information transmission unit 311, the navigation control unit 312, the travel route information acquisition unit 313, and the travel route information providing unit 314 are realized by executing a control program of the microcomputer.

The center server 100 includes as a main portion: a microcomputer including a processor including a CPU or an FPGA, and a memory including a RAM or a ROM; and a storage device such as an EPROM and a hard disk drive. As shown in FIG. 1, the center server 100 includes a communication control unit 101, a vehicle information management unit 102, a map information management unit 103, a charging infrastructure information management unit 104, and an information creation and providing unit 105. The communication control unit 101 connects to the communication network 500 to perform communication control. The vehicle information management unit 102 stores and manages vehicle information together with user information. The map information management unit 103 stores and manages road map information. The charging infrastructure information management unit 104 stores and manages information related to the infrastructure of charging facilities. The information creation and providing unit 105 creates and provides information useful to the user.

The charging infrastructure information server 300 includes as a main portion: a microcomputer including a processor including a CPU or an FPGA, and a memory including a RAM or a ROM. The charging infrastructure information server 300 collects the latest operation status of each charging facility (the non-contact power supply device 400 or a facility, such as a power supply station, where batteries are charged), and creates charging infrastructure information indicating the operation status by charging facility. The charging infrastructure information server 300 then transmits the created charging infrastructure information to the center server 100 in real time via the communication network 500. In the center server 100, the charging infrastructure information management unit 104 updates existing information with the latest charging infrastructure information transmitted from the charging infrastructure information server 300. The charging infrastructure information management unit 104 of the center server 100 stores information of positions of facilities on a map in association with map information stored in the map information management unit 103. The charging infrastructure information management unit 104 also stores power supply capacity information for each non-contact power supply device 400. This power supply capacity information defines the amount of electric power that can be supplied to the vehicle 10 when the vehicle 10 passes through a non-contact power supply location at a predetermined vehicle speed.

In the non-contact power supply system according to the embodiment, the vehicle 10 as a maintenance car travels on the road (travel road of the vehicle 10) on which the non-contact power supply device 400 is installed. Therefore, it is possible to determine whether the power supply function of the non-contact power supply device 400 is normal (failed) on the basis of the induction current of the secondary coil 61 in the vehicle 10 that is supplied with power from the non-contact power supply device 400.

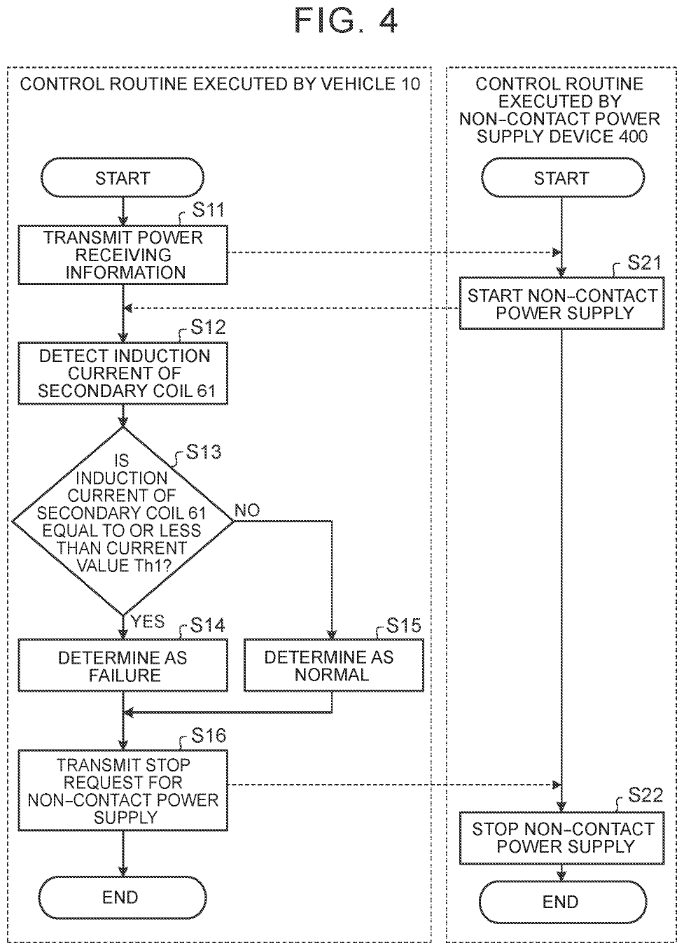

FIG. 4 is a diagram showing a first example of a power supply diagnostic control routine. The power supply diagnostic control routine shown in FIG. 4 is performed in collaboration with the vehicle 10 (power receiving ECU 65) and the non-contact power supply device 400 (power supply ECU 407). The routine consists of a control routine executed by the vehicle 10 (power receiving ECU 65) and a control routine executed by the non-contact power supply device 400 (power supply ECU 407).

In step S11, the power receiving ECU 65 of the vehicle 10 transmits power receiving information (information such as the vehicle ID and the required power) of the vehicle 10 to the non-contact power supply device 400. After acquiring the power receiving information of the vehicle 10, in step S21 the power supply ECU 407 of the non-contact power supply device 400 causes an induction current to pass through the primary coil 404 to start the non-contact power supply. When the non-contact power supply device 400 starts the non-contact power supply, the power receiving ECU 65 of the vehicle 10 detects an induction current passing through the secondary coil 61 in step S12. The power receiving ECU 65 of the vehicle 10 then determines in step S13 whether the detected induction current of the secondary coil 61 is equal to or less than a current value Th1 (first threshold value). The current value Th1 may be set in advance using, for example, the induction current of the secondary coil 61 when the power supply function is normal, based on the power receiving information of the vehicle 10. When the power receiving ECU 65 determines that the induction current of the secondary coil 61 is equal to or less than the current value Th1 (Yes in step S13), in step S14 the power receiving ECU 65 of the vehicle 10 determines that the power supply function of the non-contact power supply device 400 is failed. When the power receiving ECU 65 determines that the induction current of the secondary coil 61 is larger than the current value Th1 (No in step S13), in step S15 the power receiving ECU 65 of the vehicle 10 determines that the power supply function of the non-contact power supply device 400 is normal. After determining that the power supply function is failed in step S14 or the power supply function is normal in step S15, the power receiving ECU 65 of the vehicle 10 transmits a stop request for non-contact power supply to the non-contact power supply device 400 in step S16, and the routine ends. After the power supply ECU 407 of the non-contact power supply device 400 acquires the stop request for the non-contact power supply, the non-contact power supply is stopped in step S22, and the routine ends. The non-contact power supply may be stopped when the vehicle 10 is away from the non-contact power supply device 400 by a predetermined distance or more regardless of the stop request from the power receiving ECU 65 of the vehicle 10.

In the non-contact power supply system according to the embodiment, the power receiving ECU 65 determines whether the power supplying function of the non-contact power supply device 400 is normal (failed) in accordance with whether the predetermined induction current passes through the secondary coil 61 provided in the non-contact power receiving device 60 of the vehicle 10. Accordingly, even though the non-contact power supply device 400 does not have the function of detecting a failure of the power supply function, detection of the failure of the power supply function of the non-contact power supply device 400 can be performed by the vehicle 10.

Further, in the non-contact power supply system according to the embodiment, the non-contact power supply device 400 may have a foreign matter detection function that detects a foreign matter (metallic foreign matter) between the primary coil 404 and the secondary coil 61 so that a foreign matter is detected through foreign matter detection processing executed by the power supply ECU 407. In the foreign matter detection processing by the power supply ECU 407, a foreign matter between the primary coil 404 and the secondary coil 61 is detected, for example, based on information indicating the induction current of the secondary coil 61 acquired from the power receiving ECU 65 of the vehicle 10. Specifically, the power supply ECU 407 detects that there is a foreign matter between the primary coil 404 and the secondary coil 61 when the induction current of the secondary coil 61 is equal to or less than a current value Th2 (second threshold value) that is smaller than the current value Th1. The power supply ECU 407 may be configured to detect a foreign matter based on an induction voltage (detection voltage) instead of the induction current of the secondary coil 61. The power supply ECU 407 stops the non-contact power supply when a foreign matter is detected through the foreign matter detection processing. The power supply ECU 407 may also be configured to transmit information indicating that there is a foreign matter to the in-vehicle terminal 30 of the vehicle 10, for example, and to cause the main control unit 31 to display on the display unit 32 an image and the like alerting that there is a foreign matter so that a user is notified of detection of the foreign matter.

In the non-contact power supply system according to the embodiment, as a method of detecting a foreign matter between the primary coil 404 and the secondary coil 61, for example, an imaging device 700 such as a camera shown by a broken line in FIG. 1 is disposed on or near the non-contact power supply device 400 so as to take an image of the portion between the primary coil 404 and the secondary coil 61. The image data captured by the imaging device 700 may be then transmitted to the power supply ECU 407, and the power supply ECU 407 may perform predetermined processing on the image data and determine (detect) whether there is an foreign matter between the primary coil 404 and the secondary coil 61.

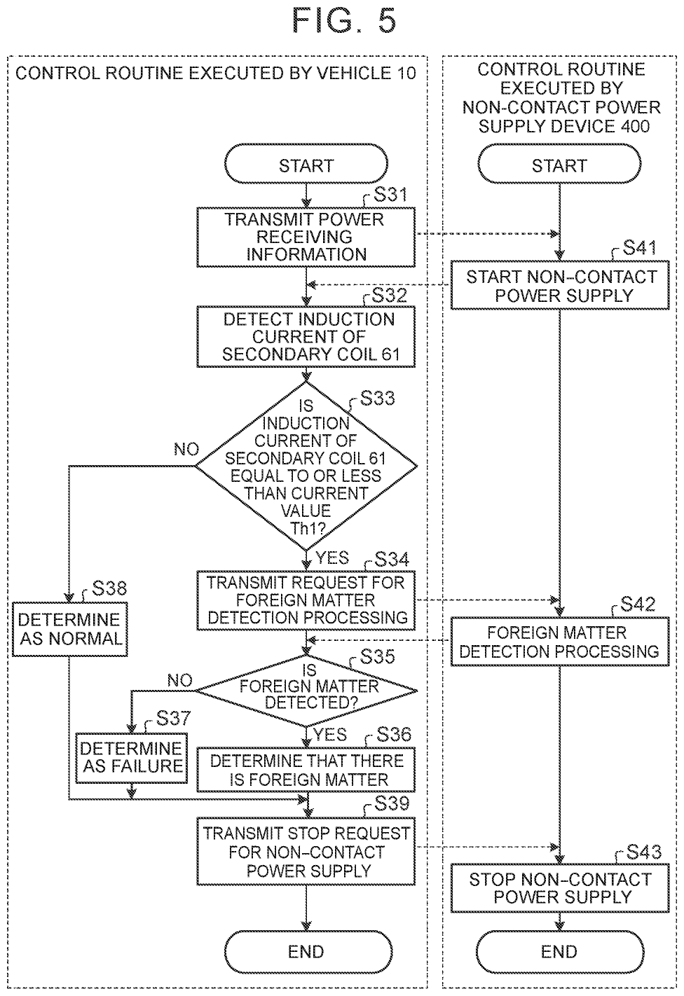

FIG. 5 is a diagram showing a second example of the power supply diagnostic control routine. The power supply diagnostic control routine shown in FIG. 5 is performed in collaboration with the vehicle 10 (power receiving ECU 65) and the non-contact power supply device 400 (power supply ECU 407). The routine consists of a control routine executed by the vehicle 10 (power receiving ECU 65) and a control routine executed by the non-contact power supply device 400 (power supply ECU 407).

In step S31, the power receiving ECU 65 of the vehicle 10 transmits power receiving information (information such as the vehicle ID and the required power) of the vehicle 10 to the non-contact power supply device 400. After acquiring the power receiving information of the vehicle 10, in step S41, the power supply ECU 407 of the non-contact power supply device 400 causes an induction current to pass through the primary coil 404 to start the non-contact power supply. When the non-contact power supply device 400 starts the non-contact power supply, the power receiving ECU 65 of the vehicle 10 detects an induction current passing through the secondary coil 61 in step S32. The power receiving ECU 65 of the vehicle 10 then determines in step S33 whether the detected induction current of the secondary coil 61 is equal to or less than the current value Th1. When the power receiving ECU 65 determines that the induction current of the secondary coil 61 is equal to or less than the current value Th1 (Yes in step S33), in step S34 the power receiving ECU 65 of the vehicle 10 transmits a request for the foreign matter detection processing to the non-contact power supply device 400. After receiving the request for the foreign matter detection processing, in step S42 the power supply ECU 407 of the non-contact power supply device 400 executes the foreign matter detection processing and transmits the processing result to the power receiving ECU 65 of the vehicle 10. In step S35, the power receiving ECU 65 of the vehicle 10 determines whether a foreign matter is detected between the primary coil 404 and the secondary coil 61 based on the acquired result of the foreign matter detection processing. When the power receiving ECU 65 of the vehicle 10 determines that a foreign matter is detected (Yes in step S35), the power receiving ECU 65 determines that there is a foreign matter between the primary coil 404 and the secondary coil 61 in step S36. On the other hand, when the power receiving ECU 65 of the vehicle 10 determines that no foreign matter is detected (No in step S35), in step S37 the power receiving ECU 65 determines that the non-contact power supply device 400 (primary coil 404) is failed. When the power receiving ECU 65 of the vehicle 10 determines that in step S33 the detected induction current of the secondary coil 61 is larger than the current value Th1 (No in step S33), the power receiving ECU 65 determines that the non-contact power supply device 400 (the primary coil 404) is normal in step S38.

After determining that: there is an foreign matter in step S36; the non-contact power supply device 400 is failed in step S37; or the non-contact power supply device 400 is normal in step S38, the power receiving ECU 65 of the vehicle 10 transmits a stop request for the non-contact power supply in step S39, and the routine ends. After the power supply ECU 407 of the non-contact power supply device 400 acquires the stop request for the non-contact power supply, the non-contact power supply is stopped in step S43, and the routine ends. The non-contact power supply may be stopped when the vehicle 10 is away from the non-contact power supply device 400 by a predetermined distance or more regardless of the stop request from the power receiving ECU 65 of the vehicle 10.

In the non-contact power supply system according to the embodiment, in the case where there is a foreign matter between the primary coil 404 and the secondary coil 61, the power receiving ECU 65 of the vehicle 10 does not determine that the non-contact power supply device 400 is failed but determines that there is a foreign matter, even though a determination that the predetermined induction current is not passing through the secondary coil 61 is made. Therefore, in the non-contact power supply system according to the embodiment, it is possible to suppress making an erroneous determination that the non-contact power supply device 400 is failed when there is a foreign matter between the primary coil 404 and the secondary coil 61.

When the non-contact power supply device 400 has the foreign matter detecting function that detects a foreign matter based on the induction current of the secondary coil 61, the vehicle 10 as a maintenance car may travel on the non-contact power supply device 400 so as to determine whether the foreign matter detection function is failed.

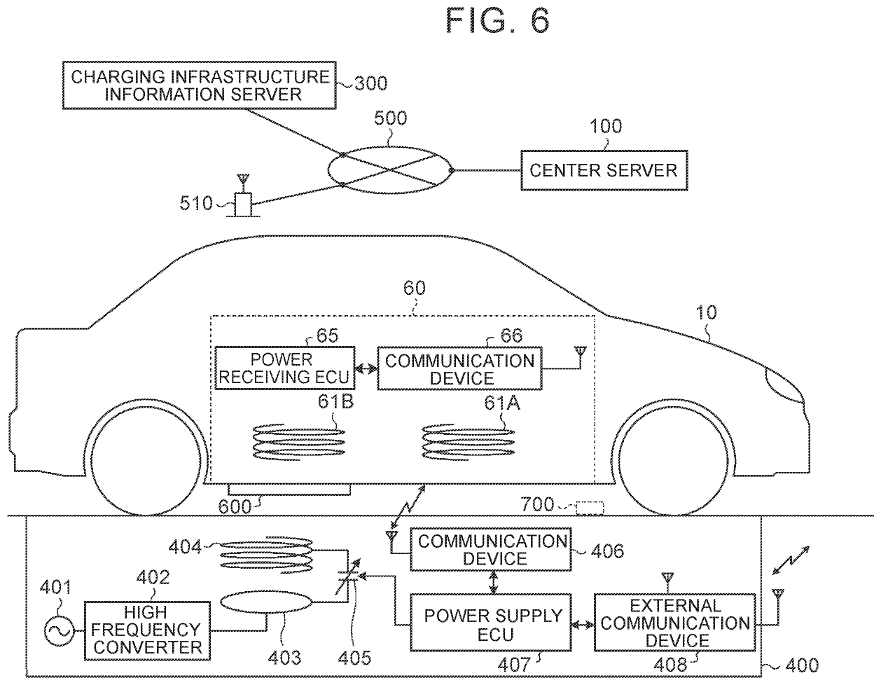

FIG. 6 is a diagram showing a case where the vehicle 10 is used to perform a power supply diagnosis and a foreign matter detection diagnosis of the non-contact power supply device 400. The non-contact power receiving device 60 of the vehicle 10 shown in FIG. 6 includes, as the power receiving coil, a first secondary coil 61A used for power supply diagnosis and a second secondary coil 61B used for foreign matter detection diagnosis. Under the second secondary coil 61B in the vehicle 10, a metallic foreign matter 600 made of a metallic plate is provided as a foreign matter between the primary coil 404 and the second secondary coil 61B.

In the non-contact power supply system according to the embodiment, a power supply diagnosis is performed as to whether the power supply function of the non-contact power supply device 400 is normal based on the induction current of the first secondary coil 61A to which electric power for power supply diagnosis is supplied from the non-contact power supply device 400. For example, when the detected induction current of the first secondary coil 61A is larger than the current value Th1, it is determined that the power supply function of the non-contact power supply device 400 is normal. On the other hand, when the detected induction current of the first secondary coil 61A is equal to or less than the current value Th1, it is determined that the power supply function of the non-contact power supply device 400 may be failed. The non-contact power supply system according to the embodiment also performs a foreign matter detection diagnosis as to whether the foreign matter detection function of the non-contact power supply device 400 is normal based on the induction current of the second secondary coil 61B to which electric power for foreign matter detection diagnosis is supplied from the non-contact power supply device 400. For example, it is determined that the foreign matter detection function is normal when the metallic foreign matter 600 of the vehicle 10 is detected after the power supply ECU 407 of the non-contact power supply device 400 acquires from the non-contact power receiving device 60 information indicating that the detected induction current of the second secondary coil 61B is equal to or less that the current value Th2. On the other hand, when the power supply ECU 407 cannot detect the metallic foreign matter 600 of the vehicle 10 because, for example, it cannot acquire the information indicating that the induction current of the detected second secondary coil 61B is equal to or less than the current value Th2, it is determined that the foreign matter detection function may be failed.

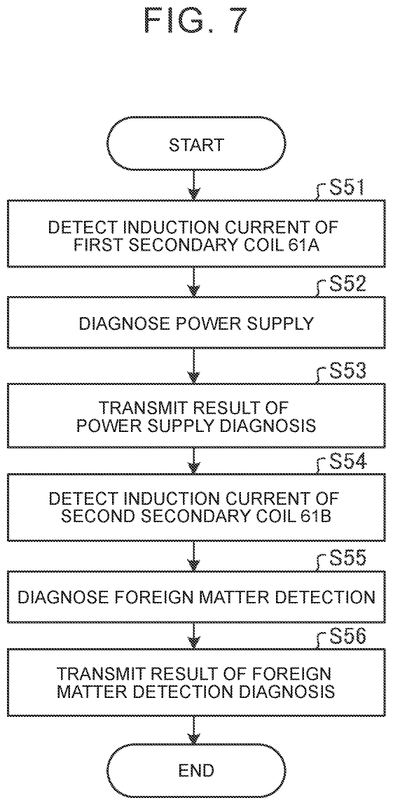

FIG. 7 is a diagram showing a control routine for the power supply diagnosis and the foreign matter detection diagnosis. In the control routine shown in FIG. 7, the vehicle 10 travels on the road on which the non-contact power supply device 400 is installed, and whether the power supply function and the foreign matter detection function of the non-contact power supply device 400 are normal (failed) is diagnosed based on the induction current of the secondary coil 61 of the vehicle 10 to which electric power for power supply diagnosis and foreign matter detection diagnosis is supplied from the non-contact power supply device 400.

In step S51, the power receiving ECU 65 of the vehicle 10 detects the induction current of the first secondary coil 61A to which electric power for power supply diagnosis is supplied from the non-contact power supply device 400. Next, in step S52, the power receiving ECU 65 of the vehicle 10 performs a power supply diagnosis as to whether the power supply function of the non-contact power supply device 400 is normal based on the detected induction current of the first secondary coil 61A. Next, in step S53, the power receiving ECU 65 of the vehicle 10 transmits the result of the power supply diagnosis, for example, from the communication device 66 to the in-vehicle terminal 30, from the in-vehicle terminal 30 to the charging infrastructure information server 300, and the like, for notification. Next, in step S54, the power receiving ECU 65 of the vehicle 10 detects the induction current of the second secondary coil 61B to which electric power for foreign matter detection diagnosis is supplied from the non-contact power supply device 400. Next, in step S55, the power supply ECU 407 of the non-contact power supply device 400 then performs the foreign matter detection diagnosis as to whether the foreign matter detection function is normal based on the induction current of the second secondary coil 61B detected by the power receiving ECU 65. Next, in step S56, the power supply ECU 407 of the non-contact power supply device 400 transmits the result of the foreign matter detection diagnosis, for example, from the communication device 406 or the external communication device 408 to the in-vehicle terminal 30 or the charging infrastructure information server 300, and the like, for notification, and the control routine ends.

In the non-contact power supply system according to the embodiment, it is possible to diagnose, using the vehicle 10, as to whether the power supply function and the foreign matter detection function of the non-contact power supply device 400 are normal in accordance with whether the predetermined induction current passes through the secondary coil 61 provided in the non-contact power receiving device 60.

When the imaging device 700 shown by the broken line in FIG. 6 is provided on or near the non-contact power supply device 400, the result of foreign matter detection by the imaging device 700 is also used to allow a more precise diagnosis of the foreign matter detection function of the non-contact power supply device 400.

Further, in the non-contact power supply system according to the embodiment, the diagnosis of the power supply function and the foreign matter detecting function of the non-contact power supply device 400 only needs to be performed by at least one of the power receiving ECU 65 of the vehicle 10 and the power supply ECU 407 of the non-contact power supply device 400 based on the induction current of the secondary coil 61. In the non-contact power supply system according to the embodiment, the power supply function of the non-contact power supply device 400 may be diagnosed by using a control device provided in a device, such as the center server 100, that is other than the vehicle 10 and the non-contact power supply device 400 based on the induction current of the secondary coil 61.

Further effects and modifications can be easily derived by those skilled in the art. The broader aspects of the disclosure are not limited to the particular details and representative embodiments shown and described above. Accordingly, various modifications may be made without departing from the spirit or scope of the general inventive concept as defined by the appended claims and their equivalents.

What is claimed is:

1. A control device comprising a processor configured to determine whether a non-contact power supply device is normal based on an induction current that passes through a power receiving coil of a non-contact power receiving device due to power supply via a power supply coil of the non-contact power supply device.

2. The control device according to claim 1, wherein:
when the induction current is larger than a first threshold value, the processor determines that the non-contact power supply device is normal; and
when the induction current is equal to or less than the first threshold value, the processor determines that the non-contact power supply device is failed.

3. The control device according to claim 1, wherein:
when the induction current is larger than a first threshold value, the processor determines that the non-contact power supply device is normal; and
when the induction current is equal to or less than the first threshold value and there is no foreign matter between the power supply coil and the power receiving coil, the processor determines that the non-contact power supply device is failed.

4. The control device according to claim 3, wherein:
when the induction current is equal to or less than the first threshold value and equal to or less than a second threshold value that is smaller than the first threshold value, the processor determines that there is a foreign matter between the power supply coil and the power receiving coil; and
when the induction current is equal to or less than the first threshold value and larger than the second threshold value, the processor determines that there is no foreign matter between the power supply coil and the power receiving coil.

5. The control device according to claim 3, wherein the processor determines whether there is a foreign matter between the power supply coil and the power receiving coil based on an image taken of a portion between the power supply coil and the power receiving coil.

6. The control device according to claim 1, wherein the processor determines whether a foreign matter detection function of the non-contact power supply device is normal based on the induction current that passes through the power receiving coil when the non-contact power supply device is caused to supply electric power for foreign matter detection.

7. A non-contact power supply diagnostic program causing a processor to determine whether a non-contact power supply device is normal based on an induction current that passes through a power receiving coil of a non-contact power receiving device due to power supply via a power supply coil of the non-contact power supply device.

8. The non-contact power supply diagnostic program according to claim 7 causing:
the processor to determine that the non-contact power supply device is normal, when the induction current is larger than a first threshold value; and the processor to determine that the non-contact power supply device is failed, when the induction current is equal to or less than the first threshold value.

9. The non-contact power supply diagnostic program according to claim 7 causing:
the processor to determine that the non-contact power supply device is normal, when the induction current is larger than a first threshold value; and the processor to determine that the non-contact power supply device is failed, when the induction current is equal to or less than the first threshold value and there is no foreign matter between the power supply coil and the power receiving coil.

10. The non-contact power supply diagnostic program according to claim 9 causing: the processor to determine that there is a foreign matter between the power supply coil and the power receiving coil, when the induction current is equal to or less than the first threshold value and equal to or less than a second threshold value that is smaller than the first threshold value; and the processor to determine that there is no foreign matter between the power supply coil and the power receiving coil, when the induction current is equal to or less than the first threshold value and larger than the second threshold value.

11. The non-contact power supply diagnostic program according to claim 9 causing the processor to determine whether there is a foreign matter between the power supply coil and the power receiving coil based on an image taken of a portion between the power supply coil and the power receiving coil.

12. The non-contact power supply diagnostic program according to claim 7 causing the processor to determine whether a foreign matter detection function of the non-contact power supply device is normal based on the induction current that passes through the power receiving coil when the non-contact power supply device is caused to supply electric power for foreign matter detection.

13. A non-contact power supply system comprising:
a non-contact power supply device including a power supply coil and a first processor; and
a control device including a second processor configured to determine whether the non-contact power supply device is normal based on an induction current that passes through a power receiving coil of a non-contact power receiving device due to power supply via the power supply coil of the non-contact power supply device.

14. The non-contact power supply system according to claim 13, wherein:
when the induction current is larger than a first threshold value, the second processor determines that the non-contact power supply device is normal; and
when the induction current is equal to or less than the first threshold value, the second processor determines that the non-contact power supply device is failed.

15. The non-contact power supply system according to claim 13, wherein:
when the induction current is larger than a first threshold value, the second processor determines that the non-contact power supply device is normal; and
when the induction current is equal to or less than the first threshold value and there is no foreign matter between the power supply coil and the power receiving coil, the second processor determines that the non-contact power supply device is failed.

16. The non-contact power supply system according to claim 15, wherein:
when the induction current is equal to or less than the first threshold value and equal to or less than a second threshold value that is smaller than the first threshold value, the first processor determines that there is a foreign matter between the power supply coil and the power receiving coil and outputs a determination result to the second processor; and
when the induction current is equal to or less than the first threshold value and larger than the second threshold value, the first processor determines that there is no foreign matter between the power supply coil and the power receiving coil and outputs a determination result to the second processor.

17. The non-contact power supply system according to claim 15, wherein:
the first processor determines whether there is a foreign matter between the power supply coil and the power receiving coil based on an image taken of a portion between the power supply coil and the power receiving coil and outputs a determination result to the second processor.

18. The non-contact power supply system according to claim 13, wherein the second processor determines whether a foreign matter detection function of the non-contact power supply device is normal based on the induction current that passes through the power receiving coil when the non-contact power supply device is caused to supply electric power for foreign matter detection.

19. The non-contact power supply system according to claim 13, wherein the control device is provided in the non-contact power receiving device.

20. The non-contact power supply system according to claim 13, wherein:
the non-contact power receiving device is provided in a vehicle; and
the non-contact power supply device is provided on a road on which the vehicle travels.
